(19) United States
(12) Patent Application Publication
(10) Pub. No.: US 2003/0018468 A1
(43) Pub. Date: Jan. 23, 2003

(54) Universal search engine

(76) Inventors: DeAnna G. Johnson, Eagle, ID (US); Bruce L. Johnson, Eagle, ID (US); Paul Leclerc, Nampa, ID (US)

Correspondence Address: HEWLETT-PACKARD COMPANY, Intellectual Property Administration, P.O. Box 272400, Fort Collins, CO, 80527-2400, US

(21) Appl. No.: 09/910,532

(22) Filed: Jul. 20, 2001

(51) Int. Cl. G06F 17/20

(52) U.S. Cl. 704/8

(57) ABSTRACT

The present disclosure relates to a universal search engine that is configured to search in any one of several different languages. The universal search engine can therefore be used in a method for conducting a search for stored information that comprises the steps of presenting a user interface to a user, receiving an identification of a particular search language in which to search, receiving a search query, and conducting a search of a database that contains information written in the identified language.

### FIELD OF THE INVENTION

The present disclosure relates to a universal search engine. More particularly, the disclosure relates to a search engine that can be used to conduct searches in several different languages.

### BACKGROUND OF THE INVENTION

Network search engines are commonly used to locate information that is accessible via the network. For instance, Internet search engines are commonly used to locate web sites and web pages. Such search engines typically receive search queries, comprising words or phrases, with a search site or page. The search engine then searches for the words and phrases in applicable databases that normally are periodically updated by a service provider that maintains and operates the search engine.

Typically, each search engine is adapted to search for information in a single language. Where the user wishes to conduct a search in another language, the user must normally access a different search site. To facilitate location of such search sites, several existing search sites provide links to other network sites that can direct the user to a search engine adapted to perform a search in the other language. Although providing the user with means to locate such search engines, the user may be forced to navigate through several network sites until finally arriving at the desired search site. This is inconvenient for the user and can cause frustration in that it may be difficult for the user to later return to the original site at which he or she began.

In an attempt to alleviate these problems, some service providers now maintain separate search sites that are capable of conducting searches of different language databases. Unfortunately, however, such arrangements create the need for additional support personnel to maintain the separate sites. In addition, the different sites often are directed at information pertaining to a particular country as opposed to a particular language, thereby limiting the amount of information that could potentially be accessed by the user.

From the foregoing, it can be appreciated that it would be desirable to have a universal search engine that is capable of conducting searches of various different language databases.

### SUMMARY OF THE INVENTION

The present disclosure relates to a method for conducting a search for stored information. In one embodiment, the method comprises the steps of presenting a user interface to a user, receiving an identification of a particular search language in which to search, receiving a search query, and conducting a search of a database that contains information written in the identified language.

This method can be practiced with a universal search engine that is configured to search in any one of several different languages. In one embodiment, the universal search engine comprises means for interfacing with a user, and means for searching one of several different available language databases in one of several different available search languages.

The present disclosure further relates to search engine software. In one arrangement, the software comprises logic configured to present a user interface to a user, logic configured to receive an identification of a particular search language, logic configured to receive a search query with the user interface, and logic configured to search a database that contains information in the identified language.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the invention.

FIG. 1 is a schematic view of an example operating environment for a universal search engine.

FIG. 2 is a schematic view of a computing device shown in FIG. 1.

FIG. 3 is a schematic view of a network server shown in FIG. 1.

FIG. 4 is a flow diagram that illustrates an example of the operation of the universal search engine shown in FIG. 3.

FIG. 5 is a schematic view of an example universal search page.

FIG. 6 is a schematic representation of the relationship between the universal search engine and a plurality of different language databases.

### DETAILED DESCRIPTION

As noted above, it would be desirable to have a search engine that can be used to conduct searches for information in various different languages. An example operating environment for such a search engine will first be discussed followed by examples as to how the search engine operates.

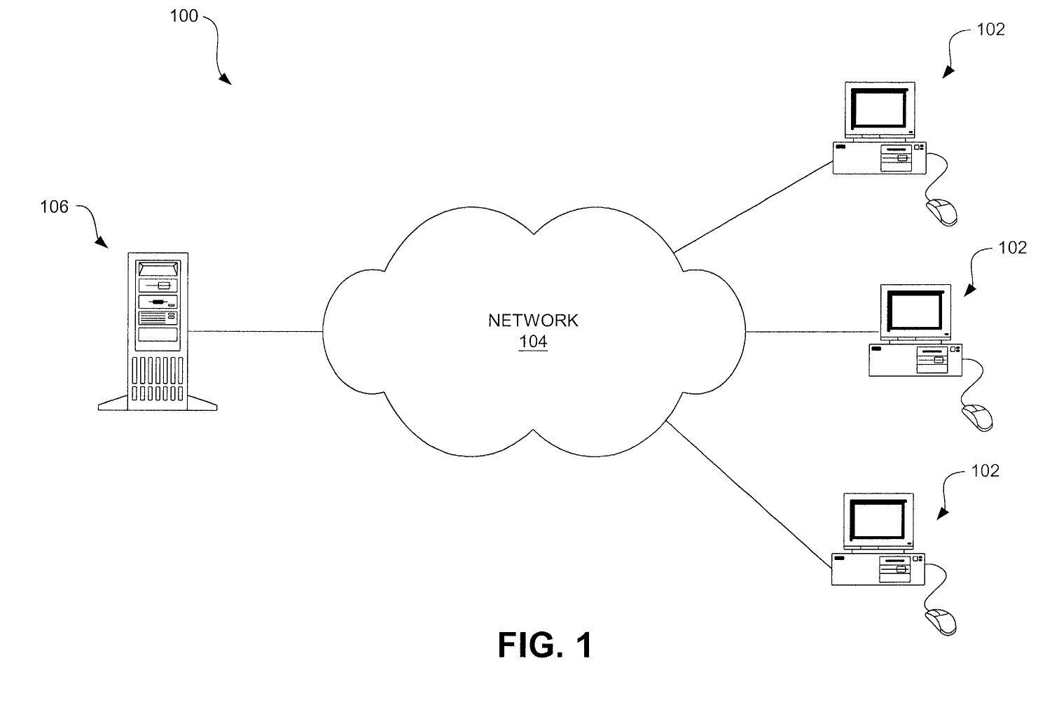

Referring now to the drawings, in which like numerals indicate corresponding parts throughout the several views, FIG. 1 illustrates an example operating environment 100 in which a universal search engine can be used. As indicated in this figure, the environment 100 can include one or more computing devices 102 that, by way of example, can comprise personal computers (PCs). As is further indicated in FIG. 1, each of the computing devices 102 can be connected to a network 104. The network 104 typically comprises one or more sub-networks that are communicatively coupled to each other. By way of example, these networks can include one or more local area networks (LANs) and/or wide area networks (WANs). Typically, however, the network 104 comprises a set of networks that forms part of the Internet. Also shown connected to the network 104 is a network server 106 that operates the universal search engine. Although a network server is described and shown, it is to be appreciated that a server is identified as an example only and is not intended to limit the scope of the present disclosure.

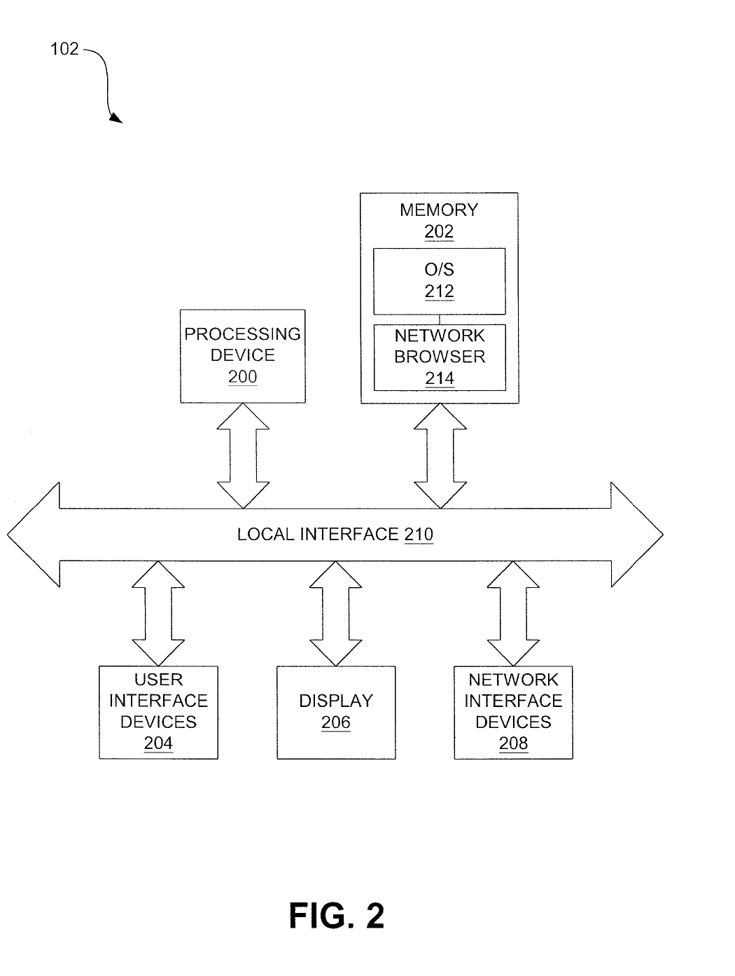

FIG. 2 is a schematic view illustrating an example architecture for the computing devices 102. As indicated in FIG. 2, each computing device 102 can comprise a processing device 200, memory 202, one or more user interface devices 204, a display 206, one or more network interface devices 208, and a local interface 210 to which each of the other components electrically connects. The local interface 210 may have additional elements, which are omitted for simplicity, such as controllers, buffers (caches), drivers, repeaters, and receivers to enable communications. Furthermore, the local interface 210 may include address, control, and/or data connections to enable appropriate communications among the aforementioned components.

The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The user interface devices 204 typically comprise those normally used in conjunction with a PC. For instance, the user interface devices 204 can comprise a keyboard and mouse. Similarly, the display 206 can comprise a display device typically used with a PC, such as a computer monitor. The one or more network interface devices 208 comprise the hardware with which the computing device 102 transmits and receives information over the network 104. By way of example, the network interface devices 208 include components that communicate both inputs and outputs, for instance, a modulator/demodulator (e.g., modem), a radio frequency (RF) or other transceiver, a telephonic interface, a bridge, a router, etc.

The memory 202 comprises various software programs including an operating system 212 and a network browser 214. The operating system 212 controls the execution of other software, such as the network browser 214, and provides scheduling, input-output control, file and data management, memory management, and communication control and related services. The network browser 214 is configured to enable connection and navigation of the network 104. By way of example, the network browser 214 can comprise a web browser such as Internet Explorer™ from Microsoft or Netscape Navigator™ from Netscape. Although the operating system 212 and the network browser 214 are the only programs identified in memory 202, persons having ordinary skill in the art will appreciate that other programs may be stored within device memory, if desired.

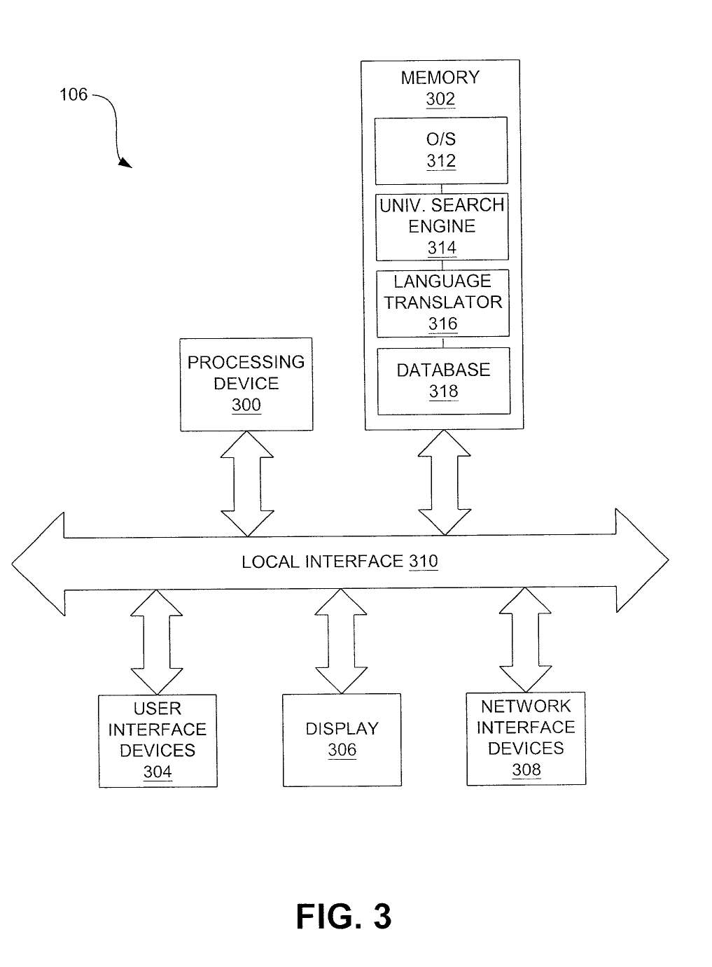

FIG. 3 is a schematic view illustrating an example architecture for the network server 106. As indicated in FIG. 3, the network server 106 can have a configuration similar to that of the computing devices 102. Accordingly, the network server 106 can comprise a processing device 300, memory 302, one or more user interface devices 304, a display 306, one or more network interface devices 308, and a local interface 310 to which each of the other components electrically connects. The processing device 300 can include any custom made or commercially available processor, a central processing unit (CPU) or an auxiliary processor among several processors associated with the network server 106, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

As with the computing devices 102, the user interface devices 304 for the network server 106 can comprise a keyboard and mouse, and the display 306 can comprise a computer monitor. The one or more network interface devices 308 comprise the hardware with which the network server 106 transmits and receives information over the network 104 and can include components that communicate both inputs and outputs, for instance, a modulator/demodulator (e.g., modem), a radio frequency (RF) or other transceiver, a telephonic interface, a bridge, a router, etc.

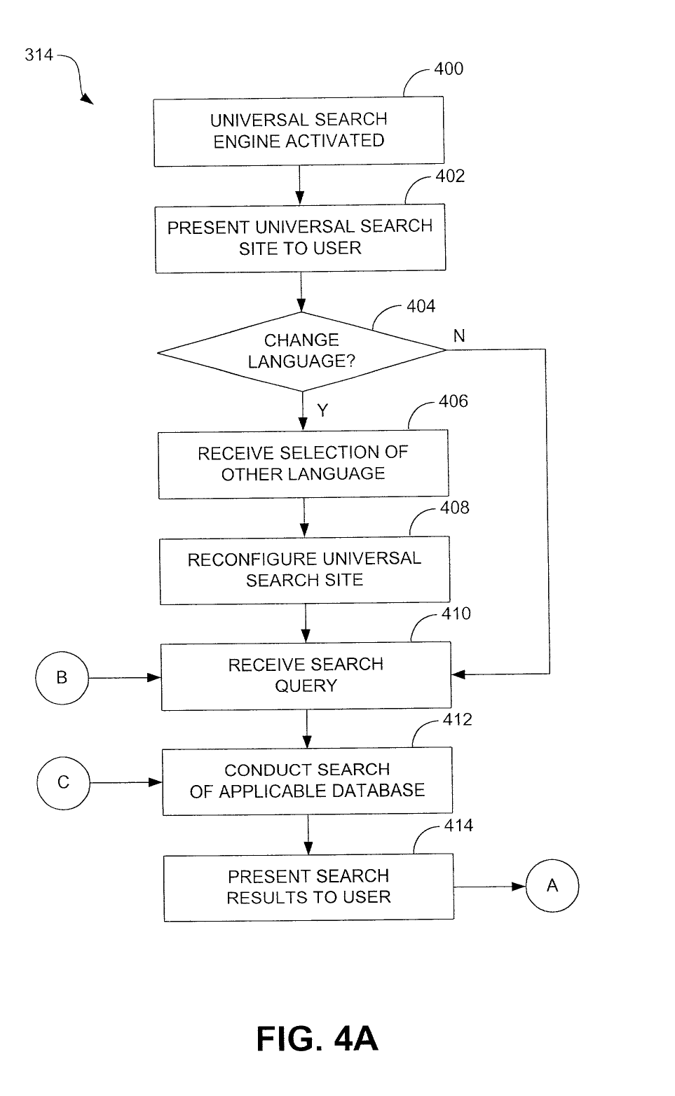

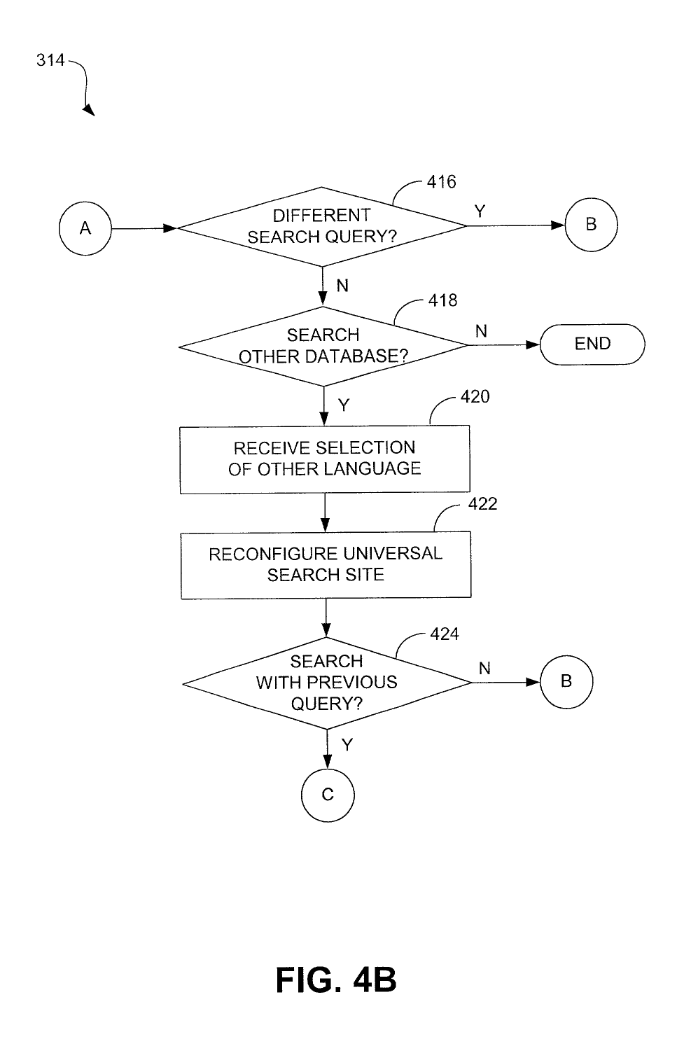

The memory 302 comprises various software programs including an operating system 312, universal search engine 314, and language translator 316. The operating system 312 controls the execution of other software, such as the universal search engine 314 and the language translator 316, and provides scheduling, input-output control, file and data management, memory management, and communication control and related services. The universal search engine 314 is configured to receive search queries and other inputs from the computing devices 102 and to conduct searches based upon the queries. The language translator 316 is configured to translate search queries input by users via the universal search engine 314 so that previous search queries can be used as the basis for searches conducted in different language databases. The operation of the universal search engine 314 and the language translator 316 is discussed below with reference to FIGS. 4-6. In addition to these programs, the memory 302 can include a database 318 that, as described below, can comprise several different language databases, each pertaining to information written within a different language.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example operating environment 100 for the universal search engine 314 having been described above, operation of the universal search engine 314 will now be discussed. In the discussion that follows, a flow diagram is provided. It is to be understood that the functional descriptions within the presented blocks and other elements of the flow diagram represent modules, segments, or portions of code that include one or more executable instructions for implementing specific logical functions or steps. Persons having ordinary skill in the art will appreciate that alternative implementations are feasible. Moreover, the functions or steps may be executed out of order from that shown or discussed, including substantially concurrently or in reverse order, depending on the functionality involved.

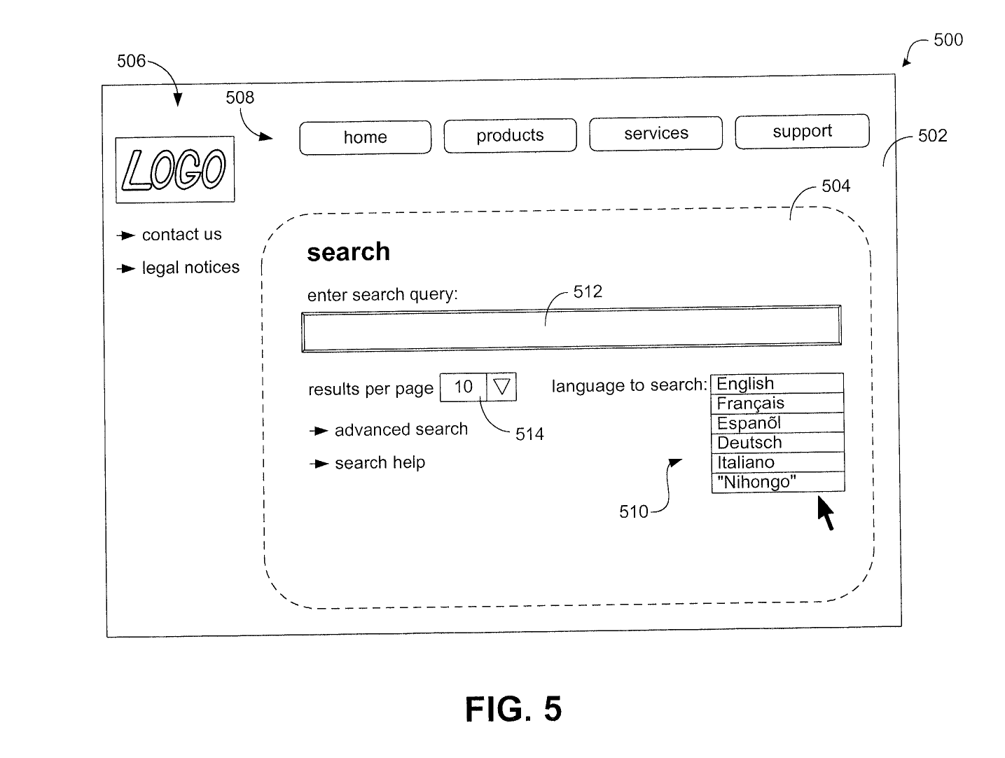

Referring now to FIGS. 4A and 4B, illustrated is an example of operation of the universal search engine 314. As indicated in block 400, the universal search engine 314 is first activated. This activation normally comprises the accessing of the universal search engine 314 with a computing device 102 by the entry of an address (e.g. universal resource locator (URL)) for a universal search site that is used to interface with the universal search engine. Once the universal search engine 314 has been activated, the universal search site can be presented to the user, as indicated in block 402, for instance with the display 206 of the user's computing device 102. An example universal search site 500 is schematically illustrated in FIG. 5. As indicated in this figure, the universal search site 500 can comprise a wrapper 502 and a body portion 504 that is, at least partially, surrounded by the wrapper. Within the wrapper 502 can be provided a side navigation bar 506 and a top navigation bar 508. Although such navigation bars 506, 508 are shown and described, it will be appreciated that these features are optional and may be omitted, if desired. Where provided, the navigation bars 506 and 508 can provide access to other network sites or pages that the user may wish to visit. As is discussed in more detail below, the body portion 504 of the universal search site 500 is used to access the universal search engine 314. Typically, the universal search site 500 is presented to the user in a default language (e.g., English) that has been pre-selected by the user or by the service provider that maintains the universal search site.

Returning to FIG. 4A, once the universal search site 500 has been presented to the user, it can be determined whether the user would like to change the search language from the default language to another language, as indicated in decision element 404. If the user does not wish to change the language, flow continues down to block 410 described below. If, on the other hand, the user does wish to change the language, flow continues to block 406 at which the user selection is received. With reference back to FIG. 5, the user selection can be received via a drop-down menu 510 which lists each of the various available language selections for the user to choose. Although various particular languages are identified in FIG. 5, it is to be understood that substantially any language could be identified in the dropdown menu 510. Furthermore, although a drop-down menu is shown and described, persons having ordinary skill in the art will appreciate that many other means for providing options to a user for selection could be used. Preferably, each language is identified in that particular language to aid the user in locating the desired language.

At this point, the universal search engine 314 reconfigures the universal search site 500, as indicated in block 408. In a preferred arrangement, the universal search site 500 is reconfigured such that the body portion 504 of the site is translated into the selected language, while the wrapper 502 of the site remains unchanged. In such a scenario, the user will appreciate that he or she is still viewing the same site at which his or her language selection was made.

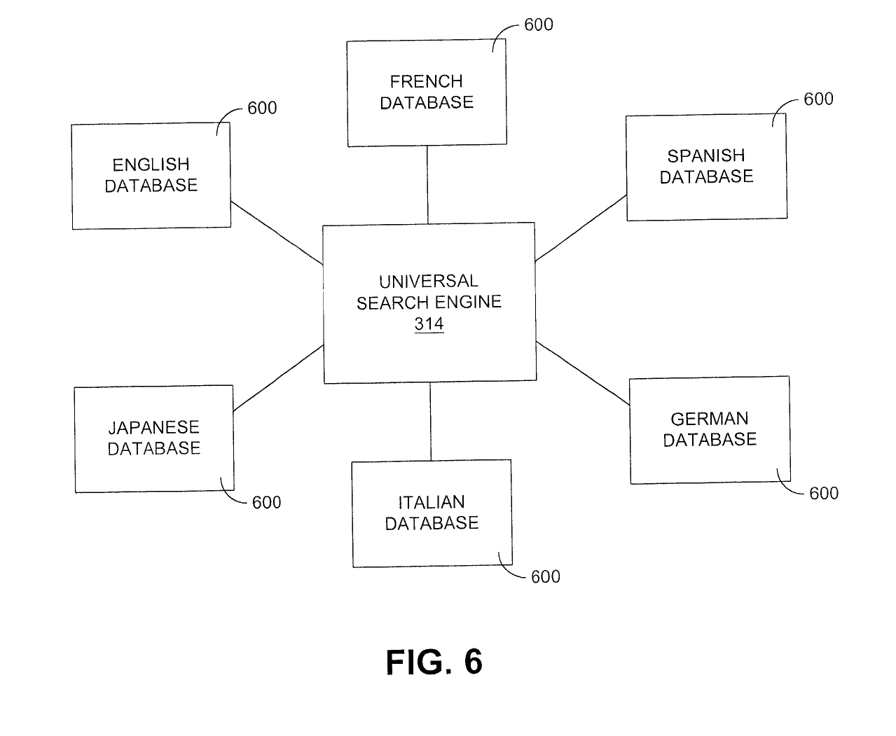

Once the universal search site 500 has been reconfigured in the manner described above, the universal search engine 314 can receive a search query from the user, as indicated in block 410. By way of example, the universal search site 500 can include a data field 512 located within the body portion 504 in which search words and/or phrases can be entered by the user. As with conventional search sites, the universal search site 500 can, optionally, permit the user to select the number of search results that will be returned via an additional data field 514. After the search query has been received, the universal search engine 314 conducts a search of the applicable database, as indicated in block 412. In that the universal search engine 314 is configured to conduct searches in several different languages, the universal search engine typically has access to several different language databases that are contained within the database 318. This relationship is schematically illustrated in FIG. 6. As indicated in this figure, the universal search engine 314 is linked to several different language databases 600. Although particular languages are identified in FIG. 6, it is to be understood that the universal search engine 314 can have access to databases containing information in substantially any language.

Returning to FIG. 4A, once the search has been conducted by the universal search engine 314, the search results can be presented to the user, as indicated in block 414. By way of example, the results can comprise titles and/or brief descriptions of one or more network sites (e.g., web sites), network pages (e.g., web pages), documents, etc. At this point, the user is free to select and/or review one or more of these results, if desired. With reference to decision element 416 of FIG. 4B, it can then be determined whether the user would like to submit a different search query and therefore conduct a new search of the current database 600. If so, flow returns to block 410 in FIG. 4A at which the new search query is received by the universal search engine 314. If not, however, flow continues to decision element 418 at which it can be determined whether the user would like to conduct a search of a different language database 600. If not, flow is terminated. If, on the other hand, the user would like to conduct a search of a different database 600, and therefore a different language, the user's language selection is received, as indicated in block 420. This selection can be received, for instance, via the drop-down menu 510 identified above, with another drop-down menu (not shown), or with some other selection facilitation interface.

Once the language selection is received, flow continues to block 422 at which the universal search site 500 is reconfigured into the selected language in the manner described above. In this scenario, however, the previously used search query is also translated into the selected language. This translation can be effected through utilization of the language translator 316. By way of example, the language translator 316 translates the words or phrases of the search query with reference to a language conversion chart or through applicable language translation algorithms. At this point, it can be determined whether the user would like to conduct a search with the, now translated, previous query, as indicated in decision element 424, or whether the user would like to conduct a new search with a different query. In the latter case, flow returns to block 410 of FIG. 4A at which the new query can be entered by the user in the manner described above. In the former case, however, flow returns to block 412 of FIG. 4A at which the search is conducted by the universal search engine 314, but this time in a different language database 600. After the user has completed his or her searches of the applicable databases 600, the user can, optionally, choose to translate the contents of the search results through use of the language translator 316 or other suitable translation means.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for conducting a search for stored information, comprising the steps of:
presenting a user interface to a user;
receiving an identification of a particular search language in which to search;
receiving a search query; and
conducting a search of a database that contains information written in the identified language.

2. The method of claim 1, wherein the user interface comprises a search site accessible via a network.

3. The method of claim 2, wherein the search site comprises a web site accessible via the Internet.

4. The method of claim 1, wherein the search language is selected from a group of several different available languages which each pertain to a different language database.

5. The method of claim 1, further comprising the step of receiving selection of a different search language in which to search.

6. The method of claim 5, further comprising the step of reconfiguring the user interface so it is presented in the different search language.

7. The method of claim 5, further comprising the step of translating the search query into the different language.

8. The method of claim 7, further comprising the step of conducting a search for the translated search query in a database containing information written in the different language.

9. The method of claim 1, further comprising translating results located during the search into a language selected by the user.

10. A universal search engine, comprising:
means for interfacing with a user; and
means for searching one of several different available language databases in one of several different available search languages.

11. The search engine of claim 10, wherein the means for interfacing with a user comprises a web site accessible via the Internet.

12. The search engine of claim 10, further comprising means for receiving selection of a different search language.

13. The search engine of claim 10, further comprising means for reconfiguring the means for interfacing with a user when a different search language is selected.

14. The search engine of claim 10, further comprising means for translating a search query into a different language.

15. The search engine of claim 14, further comprising means for searching for the translated search query in a database containing information in the different language.

16. Search engine software stored on a computer readable medium, comprising:
logic configured to present a user interface to a user;
logic configured to receive an identification of a particular search language;
logic configured to receive a search query with the user interface; and
logic configured to search a database that contains information in the identified language.

17. The software of claim 16, further comprising logic configured to receive selection of a different search language.

18. The software of claim 17, further comprising logic configured to reconfigure the user interface so as to be written in the different search language.

19. The software of claim 17, further comprising logic configured to translate the search query into the different language.

20. The software of claim 19, further comprising logic configured to search for the translated search query in a database containing information in the different language.
